(19) United States
(12) Patent Application Publication
(10) Pub. No.: US 2018/0261053 A1
(43) Pub. Date: Sep. 13, 2018

(54) DISTRESS SIGNALING DEVICE

(71) Applicant: ANDY ZILI ZHU, Dongguan (CN)

(72) Inventor: ANDY ZILI ZHU, Dongguan (CN)

(21) Appl. No.: 15/469,591

(22) Filed: Mar. 27, 2017

(30) Foreign Application Priority Data
Mar. 9, 2017 (CN) 201710139520.4

(51) Int. Cl. G08B 5/00; G08B 21/08; G08B 21/04

(52) U.S. Cl. CPC G08B 5/002; G08B 21/0453; G08B 21/088

(57) ABSTRACT

A distress signaling device is disclosed in this invention, which is provided to be utilized on the water surface or underwater and includes a carrier and a wearing module. The density of the carrier is less than the density of water. The wearing module includes a fixing member and a releasing member. The wearing module combines the carrier and the fixing member fixes the carrier with the wearing module while the releasing member allows the carrier being released from the wearing module, wherein the carrier is floating on the water after the releasing member releases the carrier from the wearing module.

### CROSS REFERENCE TO RELATED APPLICATIONS

This application claims priority to Chinese Application No. CN 201710139520.4, filed on Mar. 9, 2017, the entire contents of which are incorporated herein by reference.

### FIELD OF THE INVENTION

The present invention is related to a distress signaling technology, specifically for a user to use on the water surface or underwater in order to increase survival probability.

### BACKGROUND OF THE INVENTION

Recently, people are quite active in water activities such as swimming, surfing and diving. However, lots of danger and uncertainty, in face, hide behind these water activities.

For example, diving is a quite interesting leisure but accident also happens often. To prevent accident from happening, a diver usually wears a diving computer to record the diving time, the diving depth, the remaining amount of the oxygen in the oxygen cylinder, a heart rate of a diver and a breath number. The diving computer may also equip with a compass or underwater topographic map as well. All of this diving information is prepared to perform diving safely.

To lower the risk in diving, a distress signaling buoying is developed for diver to emit a distress call to warn a supporting staff on the surface while some unpredictable situation happens or the diver needs help. Generally speaking, this distress signaling buoying usually comprises an inflatable buoyancy bag that can be stored in a roller so that it is convenient for a diver to take with. While an emergent situation happens, the inflatable buoyancy bag can be inflated rapidly by the compressed air taken with the diver so that the inflatable buoyancy bag can be floated on the water surface. However, such inflatable buoyancy bag is usually equipped on the shoulder-strap of the diving equipment and the diver has to release it by himself when it is in-need. Under some emergent situation, it may delay the timing of distress calling.

Consequently, a distress signaling device is proposed in the present invention to resolve the disadvantage of prior art.

### SUMMARY OF THE INVENTION

A first objective of the present invention is to provide a distress signaling device is to increase the probably of being rescued while a user encounters emergent situation on the water surface or underwater.

A second objective of the present invention is to allow a user to equip with the aforementioned distress signaling device by buckle, binding or wearing.

A third objective of the present invention is according to the aforementioned distress signaling device, which further comprises a carrier and a traction member, and the traction member guide a rescuer to find the user.

A forth objective of the present invention is according to the aforementioned distress signaling device, wherein the traction member is with high tenacity such that it can drift in the water without breaking easily, and therefore it can connect the carrier and the user firmly.

A fifth objective of the present invention is according to the aforementioned distress signaling device, which allows the user to transmit information of the user such as the remaining amount of the oxygen, the consuming rate of the oxygen and the diving depth, etc., or the information of the carrier such as geographical coordination through the carrier.

To reach the abovementioned objectives and others, a distress signaling device is disclosed in the present invention for a user to use on the water surface or underwater, which comprises a carrier and a wearing module. The density of the carrier is less than that of water. The wearing module comprises a fixing member and a releasing member. The wearing module combines with the carrier. The fixing member fixes the carrier with the wearing module and the releasing member allows the carrier to be released from the wearing module, wherein the carrier floats on the water surface after the releasing member releases the carrier from the wearing module.

### BRIEF DESCRIPTION OF THE DRAWINGS

FIG. 1 is a first embodiment of the distress signaling device of the present invention.

FIG. 2 is the schematic figure of a user wearing the distress signaling device in FIG. 1.

FIG. 3 is a second embodiment of the distress signaling device of the present invention.

FIG. 4a and FIG. 4b are a third embodiment of the distress signaling device of the present invention.

FIG. 5 is a fourth embodiment of the distress signaling device of the present invention.

### DETAILED DESCRIPTION OF THE PREFERRED EMBODIMENTS

To fully comprehend the objective, feature and function of the present invention, a detailed description of the present invention is presented by the specific embodiments below along with the accompanying figures.

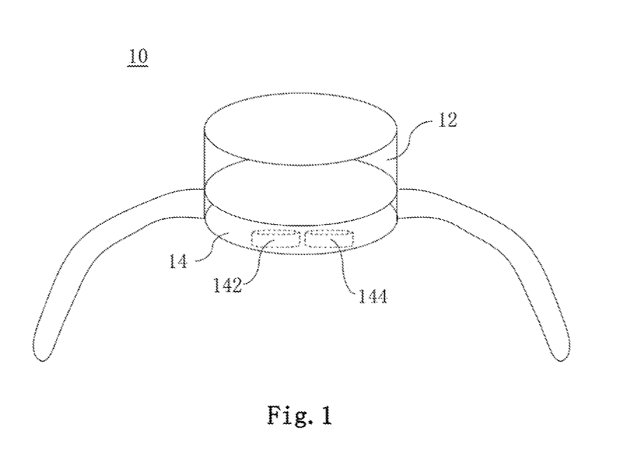

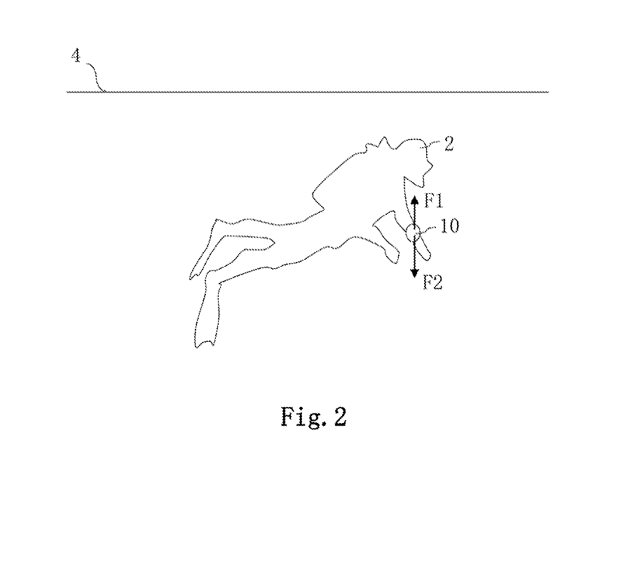

Please refer to FIG. 1, which is a schematic figure a first embodiment of the distress signaling device of the present invention. In FIG. 1, the distress signaling device 10 allows a user 2 to use on the surface of water 4 or underwater. The application scenario can be referred to FIG. 2 as well, which schematically describe how the user wearing the distress signaling device 10 of FIG. 1 in the present invention.

In FIG. 1, the distress signaling device 10 comprises a carrier 12 and a wearing module 14.

The density of the carrier 12 is less than that of water 4 such that buoyancy F1 is generated while the carrier 12 is set under water 2. The morphology of the carrier 12 may be a substantial body or an envelope or a combination thereof. Take substantial body for example, the material of the substantial carrier 12 is with high buoyancy such as Ethylene vinyl acetate copolymer, sponge, foam or plastics; and take envelope for example, a gas such as hydrogen or oxygen may be used to fill the envelope to provide buoyancy. It is worthy to be noted that the material of the envelope may be the same as that of the substantial body. By the feature of the carrier 12, the carrier 12 may float on the surface of water 4 or sinking and rising. (i.e., the carrier 12 is floating and sinking all the time.)

The wearing module 14 combines with the carrier 12. In this embodiment, the wearing module is presented by an example of a wrist straps. The user 2 may wear the wearing module 14 on the wrist. In other embodiments, the wearing module 14 may be equipped with the user 2 by other means such as shoulder straps, belt or other accessories on the other positions of the user 2 such as chest, waist or shoulder.

The wearing module 14 comprises a fixing member 142 and a releasing member 144. In this embodiment, the shape of the wearing module 14 is exemplified by a circle. In other embodiments, the shape may be replaced by any other kinds of shapes. The fixing member 142 fixes the carrier 12 with the wearing module 14. Fixing member 142 provides a force F2 equal to or greater than F1 with opposite direction. In this embodiment, the fixing member 142 may be by means of buckle or magnetic element. Therefore, the user 2 may still dive under water 2 after wearing the distress signaling device 10. Besides, the releasing member 144 allows the member 12 to be released from the wearing module 14. For example, the releasing member 144 may be a buckle at a releasing state or a mechanical part with magnetic attraction released. Furthermore, after the releasing member 144 releases the carrier 12 from the wearing module 14, the buoyance F1 of the carrier is no longer constrained by the force F2 and since the density of the carrier 12 is less than that of water 4 such that the carrier 12 floats on the surface of water 4 and a rescuer may consequently find the user 2 according to the carrier 12.

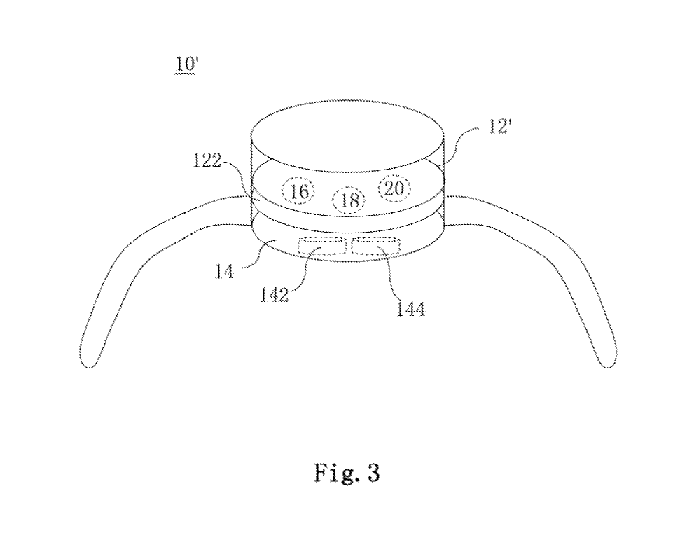

Please refer to FIG. 3, which is a schematic figure of a second embodiment of the present invention. In FIG. 3, the distress signaling device 10′ further forms a holding space 122 in addition to the wearing module 14 in the first embodiment and further comprises a signal transmitting module 16, a power supplying module and a detection module 20.

In this embodiment, the holding space 122 may form at a lower surface. In other embodiments, the holding space 122 may form at one of an upper surface, a lateral surface or within the carrier.

The signal transmitting module 16 is provided within the holding space 122. The signal transmitting 16 may transmit a GPS, sound, light, radio signal or supersonic signals, etc. For example, while the signal transmitting module 16 is a GPS transmitting module, it may locate a geographical coordination of the carrier 12 and broadcast or/and distribute the geographical coordination from the surface of water 4. For example, the geographical coordination may be transmitted to the rescuer such that the rescuer may learn the location of the carrier 12 and the location of the user 2 may be further tracked. While the signal transmitting module 16 transmits sound or light, the sound and light may locate the position of the carrier 12 on the surface of water so that the rescuer may learn the position of the carrier 12 and the location of the user 2 may be further tracked. While the signal transmitting module 16 transmits a radio frequency signal, the radio frequency signal is transmitted at a specific frequency and amplitude to represent an S.O.S signal or Morse code such that a rescuer may learn that the user 2 encounters some emergent situation and initiate rescuing or searching then.

A power supply module 18 is provided within the holding space 122 and it can be a general battery or a solar cell, for example. The power supply module 18 generates a power to drive the signal transmitting module 16.

A detection module 20 is provided within the holding space 122. The detection module determines whether the signal transmitting module shall be turned on or not according an external environmental factor such as the intensity of the light.

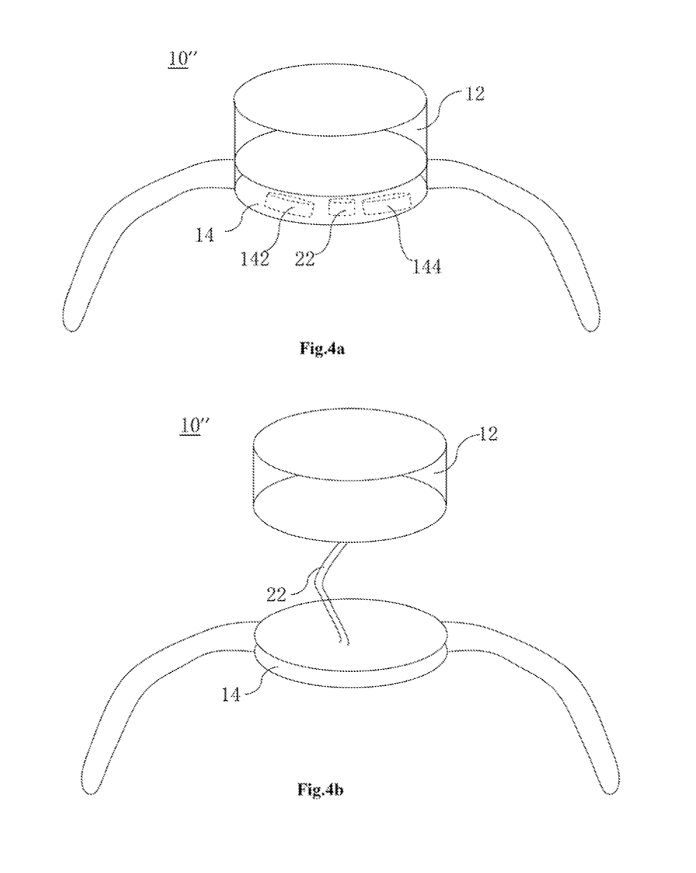

Please refer to FIG. 4a and FIG. 4b, which are the schematic figures of a third embodiment of the distress signaling device of the present invention. In FIG. 4a, the distress signaling device 10″ further comprise a traction member 22 in addition to the carrier 12 and the wearing module 14.

The traction member 22 may be a string or a chain. The material of the traction member may be with high tenacity to prevent waves, fish or rocks from breaking the connection between the carrier and the user 2. The traction member 22 connects the carrier 12 by a first state or a second state. In this embodiment, the traction member 22 is exemplified by a string. The first state is the string without being pulled and dragged, which means the traction member 22 is not working as FIG. 4a shows. The second state means the string is pulled and dragged by the buoyancy F2, which means the traction member 22 is working by the buoyance F2 as shown in FIG. 4b.

It is worthy to note that the carrier 12 may form a holding space 122. The holding space 122 may forms at one of an upper surface, a lower surface, a lateral surface and within the interior of the carrier. In this embodiment, the holding space 122 is provided to contain the traction member 22.

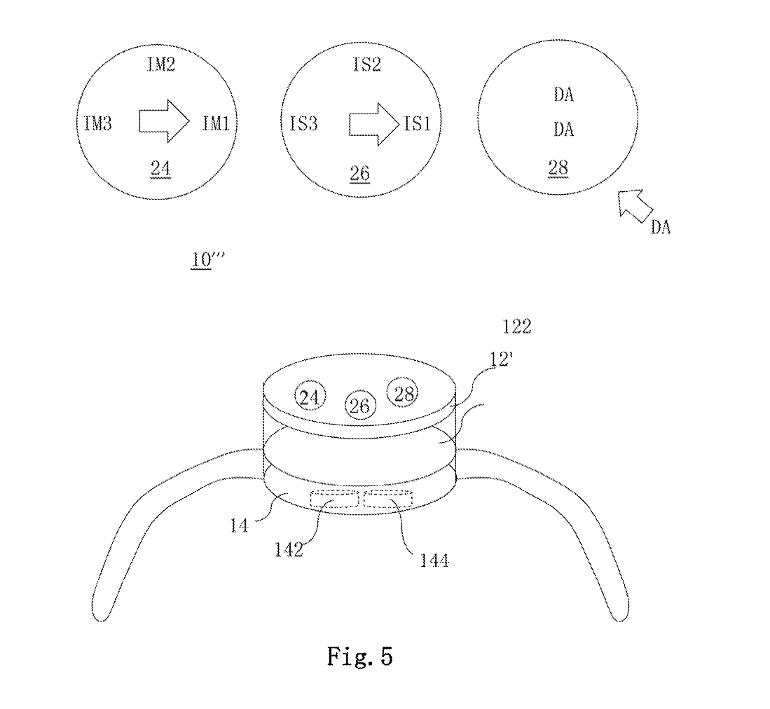

Please refer to FIG. 5, which is a schematic figure of a forth embodiment of the distress signaling device of the present invention. In FIG. 5, the distress signaling device 10′″ comprises the wearing module 14 as the first embodiment, and the carrier 12′ further comprises a holding space 122 and further comprises a first indication module 24, a second indication 26 and a display module 28.

The first indication module 24 is provided on the upper surface of the holding space 122. The first indication module 24 have a plurality of the indicator IM1, IM2, IM3 and each of the indicators IM1, IM2, IM3 corresponds to a state for a user 2 to select at least one of the plurality of indicators IM1, IM2, IM3, wherein the indicators IM1, IM2, IM3 may be at least one of cramp, hypoxia, hypothermia, incapable of moving and in-danger.

The second indication 26 is provided at the upper surface of the holding space 122. The second indication 26 have at least one of the indicator IS1, IS2, IS3, wherein the indicators IS1, IS2, IS3 correspond to at least one of the vital sign of the user and a state of a diving equipment (such as an oxygen cylinder and a diving computer) of the user, wherein the indicator IS1, IS2, IS3 may be at least one of the amount of oxygen, a consuming rate of oxygen, an amount of carbon dioxide, an oxygen usage time and a diving depth of the user under water 4.

The display module 28 is provided at the upper surface of the holding space 122. The display module 28 may display one of a vital sign of the user and a state related to a diving equipment of the user according information DA, wherein the information DA is generated from the diving equipment of the user 2.

Although the embodiments of the present invention are disclosed as above, these embodiments shall not be considered to restrict the present invention. Those modifications that Person having ordinary skill in the art may make to the shape, structure, feature, method and/or quantity according to the claims of the present invention shall be covered by the scope of the present invention and the protected scope of the present invention shall be considered by the claims attached to this specification.

1. (canceled)

2. (canceled)

3. (canceled)

4. (canceled)

5. A distress signaling device for a user to be used on a water surface or underwater comprising:
a carrier, of which the density is less than then density of water and forms a holding space;
a wearing module comprising a fixing member and a releasing member, wherein the wearing module combines the carrier, and the fixing member fixes the carrier with the wearing module and the releasing member allows the carrier to be released from the wearing module; wherein the carrier floats on the water surface after the releasing member releases the carrier from the wearing module; and
a signal transmitting module provided in the holding space, wherein the signal transmitting module locates a geographical coordinate of the carrier and further broadcasts and distribute the geographical coordinate of the carrier.

6. The distress signaling device of claim 5, further comprising a power supply module, wherein the power supply module is provided within the holding space and the power supply module generates a power to drive the signal transmitting module.

7. The distress signaling device of claim 5, further comprising a detection module provided within the holding space, and the detection module determines to turn on the signaling module according to an intensity of light.

8. The distress signaling device of claim 5 further comprising a first indication module provided within the holding space, where in the first indication module comprises a plurality of indicators, each of which corresponds to a state for a user to select from a plurality of states according to his/her states.

9. The distress signaling device of claim 8, wherein the plurality of states are at least one of cramp, hypoxia, hypothermia, incapable of moving and in-danger.

10. The distress signaling device of claim 5 further comprising a second indication module provided within the holding space, wherein the second indication module comprises at least one indicator corresponding to at least one of a vital sign of the user and states of diving equipment of the user.

11. The distress signaling device of claim 10, wherein the indicator is at least one of an amount of oxygen, a consuming rate of oxygen, an amount of carbon dioxide, a usage time of oxygen and a depth underwater that the user locates.

12. The distress signaling device of claim 5, further comprising a display module provided within the holding space, wherein the display module displays at least one of a vital sign of the user and a state related to a diving device of the user according to information generated from diving equipment of the user.

13. The distress signaling device of claim 5, wherein the wearing module further comprises a traction member, which is connected to the carrier with a first state or a second state, wherein the traction member performs the first state by the fixing member and the traction member performs the second state by the releasing member.

14. (canceled)

15. (canceled)

16. (canceled)

17. (canceled)

18. (canceled)

19. (canceled)

20. The distress signaling device of claim 8, wherein the plurality of states are at least one of cramp, hypoxia, hypothermia, incapable of moving and in-danger.
